(19) United States
(12) Patent Application Publication
(10) Pub. No.: US 2008/0079689 A1
(43) Pub. Date: Apr. 3, 2008

(54) Rotating UI for better usage

(75) Inventor: Sanna M. Koskinen, Tampere (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/540,951

(22) Filed: Oct. 2, 2006

(51) Int. Cl. G09G 5/00

(52) U.S. Cl. 345/156

(57) ABSTRACT

A method for a user interface is disclosed. The method comprises determining an orientation of a display of the user interface; adapting a display view of said display depending on said determined orientation; and assigning functions to input means of said user interface depending on said determined orientation. A user interface, an apparatus and a computer program for implementing the method is also disclosed.

### TECHNICAL FIELD

The present invention relates to a method for a user interface, a user interface, an apparatus, and a computer program.

### BACKGROUND OF THE INVENTION

Portable electronic devices becomes more and more advanced. This puts higher demands on making the apparatus user-friendly. WO 2005/052773 A2 discloses a method for changing an orientation of a user interface, comprising detecting a course of motion that is performed on the user interface, and changing the orientation of the user interface with respect to a device, in which the user interface is integrated, according to the detected course of motion. However, there are further possibilities for improving a user interface.

### SUMMARY OF THE INVENTION

In view of the above, an objective of the invention is to solve or at least reduce the problems discussed above. In particular, an objective is to provide a user interface responsive to the physical orientation.

According to a first aspect of the present invention, there is provided a method for a user interface comprising determining an orientation of a display of the user interface; adapting a display view of said display depending on said determined orientation; and assigning functions to input means of said user interface depending on said determined orientation.

The assignment of functions and adaption of the display view may be performed for adapting to either right hand use or left hand use.

The method may further comprise receiving information on said orientation from a user.

The method may further comprise receiving information on said orientation a sensor.

The input means that is being assigned functions depending on said determined orientation may comprise dedicated function buttons.

The input means that is being assigned functions depending on said determined orientation may comprise a rotatable dial.

The method may further comprise launching an application depending on the determined orientation.

According to a second aspect of the present invention, there is provided a user interface comprising a display arranged to display a display view; input means arranged to receive user input; an orientation handler arranged to determine an orientation of said display; and a functionality handler arranged to adapt said display view and assigned functions of said input means depending on a determined orientation provided by said orientation handler.

The assignment of functions and adaption of the display view may be performed for adapting to either right hand use or left hand use.

Information on said orientation may be provided by the user, or by a sensor.

The input means may comprise dedicated function buttons, wherein said dedicated function buttons may be assigned functions depending on said determined orientation.

The input means may comprise a rotatable dial, wherein said rotatable dial may be assigned functions depending on said determined orientation.

The user interface may be arranged to launch an application depending on the determined orientation.

The user interface may further be arranged to provide a visual indicia for said input means depending on the assigned functions. The visual indicia may be a color coding. The visual indicia may comprise a light emitting diode.

According to a third aspect of the present invention, there is provided an apparatus comprising a user interface comprising a display arranged to display a display view; input means arranged to receive user input; a processor controlling said user interface and comprising an orientation handler arranged to determine an orientation of said display; and a functionality handler arranged to adapt said display view and assigned functions of said input means depending on a determined orientation provided by said orientation handler.

The processor may be arranged to launch an application depending on the determined orientation.

The apparatus may be a mobile communication apparatus, a portable digital assistant, a portable media player, a digital camera, or a cell phone.

According to a fourth aspect of the present invention, there is provided a computer-readable medium having computer-executable components comprising instructions for determining an orientation of a display of the user interface; adapting a display view of said display depending on said determined orientation; and assigning functions to input means of said user interface depending on said determined orientation.

The computer-readable medium may further comprise instructions for receiving information on said orientation from a user, instructions for receiving information on said orientation a sensor, and/or instructions for launching an application depending on the determined orientation.

Generally, all terms used in the claims are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

Other objectives, features and advantages of the present invention will appear from the following detailed disclosure, from the attached dependent claims as well as from the drawings.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 is a flow chart illustrating a method according to an embodiment of the present invention;

FIG. 2 is a flow char illustrating an example how the present invention can be used;

FIG. 3 schematically illustrates a user interface according to an embodiment of the present invention;

FIG. 4 schematically shows an apparatus according to an embodiment of the present invention;

FIGS. 5a and 5b shows an apparatus in different orientations;

FIGS. 6a and 6b shows corresponding display views for different orientations of a display; and

FIGS. 7a to 7c illustrate how a determined orientation of an apparatus can be used.

### DETAILED DESCRIPTION OF PREFERRED EMBODIMENTS

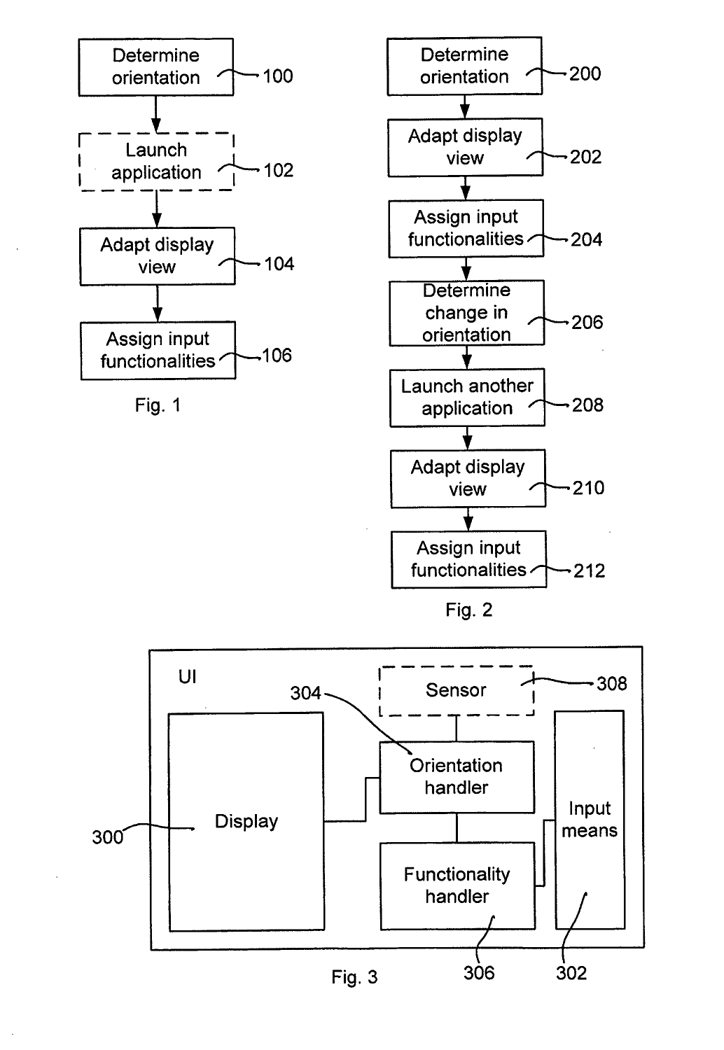

FIG. 1 is a flow chart illustrating a method according to an embodiment of the present invention. An orientation of a display showing a display view is determined 100. For example, in a monoblock apparatus with a single display, the orientation of the display will be the orientation of the apparatus. In an apparatus with more than one display, it has to be determined which display that shows the actual display view, and if the display is hingably or rotatable attached to the apparatus, this can be considered.

Optionally, an application is launched 102 based on the determined orientation. For example, a camera application is launched when a certain orientation is determined, where this orientation preferably is when the apparatus and its display is particularly suitable for capturing images.

The display view is adapted 104 with regard to the determined orientation, as will be further discussed in a few examples with reference to FIGS. 5 to 7. Further, functions of input means are assigned 106 depending on the determined orientation.

FIG. 2 is a flow char illustrating an example how the present invention can be used. It can be assumed that an application is running on an apparatus being used by a user. An orientation of the display is determined 200, and the display view is adapted 202 accordingly for the running application, for example a camera application. Further, functions of certain input means are assigned 204 in a suitable manner according to the running application and the determined orientation. To continue with the example with the camera application, a key suitably placed in the current orientation for releasing the shutter can be assigned as a shutter release. When a picture is shot, the user intends to use the captured image, and turns e.g. the entire apparatus to a position such that the display gets another orientation. Thus is a change in orientation determined 206, and another application is launched 208 based on the new determined orientation. This can for example be a messaging application, where the user is enabled to send a message comprising the captured image. The display view is adapted 210 to the new determined orientation, and functions of some input means can also be re-assigned 212 in accordance with the new determined orientation. An example of this can be that the display view is turned with regard to selectable options, that the input means are re-assigned to be easily maneuvered in the current position, e.g. using only one hand. In the messaging example, input means for scrolling and selecting can be re-assigned for easier selecting options and for selecting a recipient from e.g. a contact list.

FIG. 3 schematically illustrates a user interface UI according to an embodiment of the present invention. The user interface UI comprises a display 300 and input means 302. The input means 302 can comprise a keypad, a touch screen, a rotating dial, one or more soft keys working in conjunction with presented options on the display, certain function specific keys or buttons, navigation keys, a joystick, etc. The user interface further comprises an orientation handler 304 arranged to determine the current orientation on the display and provide necessary information on this to e.g. a function handler 306 assigning functions to input means depending on the current orientation provided by the orientation handler. The orientation handler 304, as well as the function handler 306, are suitable to implement as software modules in a processor, but can also be hard-wired, or implemented as a combination between software and hardware. Optionally, the orientation handler 304 receives a signal from a sensor 308, from which signal the orientation handler 304 can determine the orientation. The sensor 308 can comprise an accelerometer, a gyro, one or more switches at a hinged connection between the display and a main body of an apparatus having the display, or any other means for providing a signal indicating the orientation. Alternatively, the orientation can be determined by enabling a user to input the current orientation, or by predicting the most possible orientation depending on e.g. the used application. The functions and operation of the user interface UI will become more clear from the examples discussed with reference to FIGS. 5 to 7.

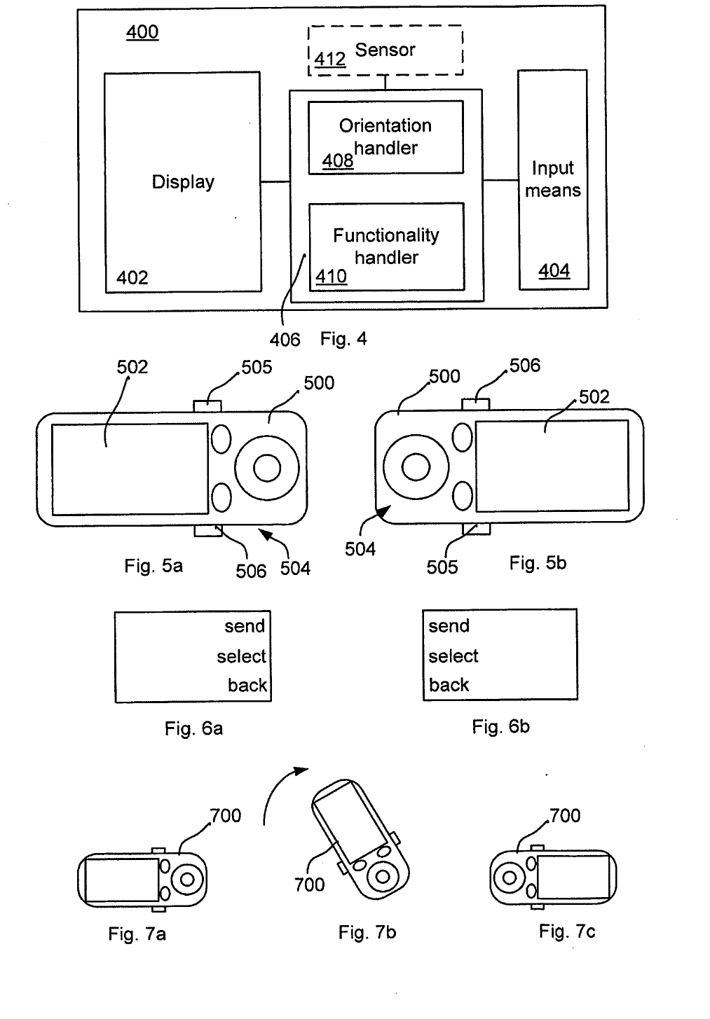

FIG. 4 schematically shows an apparatus 400 according to an embodiment of the present invention. The apparatus comprises a display 402 and input means 404. Examples on these elements 402, 404 are similar to those demonstrated for the user interface discussed with reference to FIG. 3, and can be considered to be at least a part of the user interface of the apparatus 400. Not to obscure the invention, other parts of the apparatus 400, which parts can comprise image capturing means, transmitter, receiver, memory, casing, antenna, etc., are not discussed in this disclosure. However, the apparatus 400 comprises a processor 406 implementing, among other things which are neither discussed here to avoid obscuring the invention, an orientation handler 408 and a function handler 410. The orientation handler 408 is arranged to determine the current orientation on the display 402 and provide necessary information on this to e.g. the function handler 410 assigning functions to at least certain of the input means 404 depending on the current orientation provided by the orientation handler 408. The orientation handler 408, as well as the function handler 410, are implemented by the processor as software modules in a processor, but can also be hard-wired as in an ASIC, or implemented as a combination between software and hardware as in an FPGA. Optionally, the orientation handler 408 receives a signal from a sensor 412 of the apparatus 400, from which signal the orientation handler 408 can determine the orientation. The sensor 412 can comprise an accelerometer, a gyro, one or more switches at a hinged connection between the display and a main body of an apparatus having the display, or any other means for providing a signal indicating the orientation. The sensor 412 can comprise one or more of these elements, of a sole type or several types in combination. Alternatively, the orientation can be determined by enabling a user to input the current orientation, or by predicting the most possible orientation depending on e.g. the used application. The functions and operation will become more clear from the examples discussed with reference to FIGS. 5 to 7.

FIGS. 5a and 5b shows an apparatus 500 comprising a display 502 and input means 504. Note the exaggerated size of keys 505, 506, which size is only for illustrative purposes.

A use case is a right-handed user using the apparatus 500 as a camera, and thus preferring to use the apparatus 500 in the orientation illustrated in FIG. 5a to be able to operate the input means 504, 505, 506 without obscuring the display 502 with the hand. During similar use, a left-handed user would use the apparatus 500 in the orientation illustrated in FIG. 5b. The most natural way to release a shutter of the camera would for the right-handed person be to use key 505 being on top of the apparatus 500 in the right-handed orientation illustrated in FIG. 5a, while the left-handed person would use key 506 being on top of the camera in the left-handed orientation illustrated in FIG. 5b. Thus is the assignment of the functions of keys 505, 506 made dependent on the determined operation.

FIGS. 6a and 6b shows corresponding display views for different orientations of a display, cf. the orientation of the apparatus in FIGS. 5a and 5b. Not only that the display view is arranged not to present the displayed information upside down, but for example selectable options are moved in the display view to facilitate association with e.g. soft keys. In FIGS. 6a and 6b, we also see that the options are arranged such that the user experience them to be in the same order to be able to easily recognize the selectable items. Thus, functions of any corresponding soft keys will have to be assigned accordingly.

FIGS. 7a to 7c illustrate how a determined orientation of an apparatus 700 can be used for further improving user-friendliness. A first application is run on the apparatus 700 when in the orientation illustrated in FIG. 7a, e.g. capturing an image. The user turns the apparatus 700 as illustrated in FIG. 7b, where a sensor (not shown) in the apparatus enables determination on a change in orientation to the orientation illustrated in FIG. 7c. Upon the determination on a new orientation, the apparatus launches a new application, preferably linking available information from the application run in the first orientation, such as importing a captured image in FIG. 7a to the new launched application in FIG. 7c, which can be a messaging application, an image editor, a photo album, etc. The user can then easily and intuitively use the apparatus 700.

The invention has mainly been described above with reference to a few embodiments. However, as is readily appreciated by a person skilled in the art, other embodiments than the ones disclosed above are equally possible within the scope of the invention, as defined by the appended patent claims.

1. A method for a user interface comprising
determining an orientation of a display of the user interface;
adapting a display view of said display depending on said determined orientation; and
assigning functions to input means of said user interface depending on said determined orientation.

2. The method according to claim 1, wherein said assignment of functions and adaption of the display view is performed for adapting to either right hand use or left hand use.

3. The method according to claim 1, further comprising receiving information on said orientation from a user.

4. The method according to claim 1, further comprising receiving information on said orientation a sensor.

5. The method according to claim 1, wherein said input means being assigned functions depending on said determined orientation comprises dedicated function buttons.

6. The method according to claim 1, wherein said input means being assigned functions depending on said determined orientation comprises a rotatable dial.

7. The method according to claim 1, further comprising launching an application depending on the determined orientation.

8-9. (canceled)

10. A user interface comprising
a display arranged to display a display view;
input means arranged to receive user input;
an orientation handler arranged to determine an orientation of said display; and
a functionality handler arranged to adapt said display view and assigned functions of said input means depending on a determined orientation provided by said orientation handler.

11. The user interface according to claim 10, wherein assignment of functions and adaption of the display view is performed for adapting to either right hand use or left hand use.

12. The user interface according to claim 10, wherein information on said orientation is provided by the user.

13. The user interface according to claim 10, wherein information on said orientation is provided by a sensor.

14. The user interface according to claim 10, wherein said input means comprises dedicated function buttons, wherein said dedicated function buttons are assigned functions depending on said determined orientation.

15. The user interface according to claim 10, wherein said input means comprises a rotatable dial, wherein said rotatable dial is assigned functions depending on said determined orientation.

16. The user interface according to claim 10, being arranged to launch an application depending on the determined orientation.

17. The user interface according to claim 10, further being arranged to provide a visual indicia for said input means depending on the assigned functions.

18. The user interface according to claim 17, wherein said visual indicia is a color coding.

19. The user interface according to claim 17, wherein said visual indicia comprises a light emitting diode.

20. An apparatus comprising
a user interface comprising
a display arranged to display a display view;
input means arranged to receive user input;
a processor controlling said user interface and comprising
an orientation handler arranged to determine an
orientation of said display; and
a functionality handler arranged to adapt said display view and assigned functions of said input means depending on a determined orientation provided by said orientation handler.

21. The apparatus according to claim 20, wherein assignment of functions and adaption of the display view is performed for adapting to either right hand use or left hand use of the apparatus.

22. The apparatus according to claim 20, wherein information on said orientation is provided by the user.

23. The apparatus according to claim 20, wherein information on said orientation is provided by a sensor.

24. The apparatus according to claim 20, wherein said input means comprises dedicated function buttons, wherein said dedicated function buttons are assigned functions depending on said determined orientation.

25. The apparatus according to claim 20, wherein said input means comprises a rotatable dial, wherein said rotatable dial is assigned functions depending on said determined orientation.

26. The apparatus according to claim 20, wherein said processor is arranged to launch an application depending on the determined orientation.

27. The apparatus according to claim 20, further being arranged to provide a visual indicia for said input means depending on the assigned functions.

28. The apparatus according to claim 27, wherein said visual indicia is a color coding.

29. The apparatus according to claim 27, wherein said visual indicia comprises a light emitting diode.

30. The apparatus according to claim 20, belonging to a group comprising a mobile communication apparatus, a portable digital assistant, a portable media player, a digital camera, and a cell phone.

31. A computer-readable medium having computer-executable components comprising instructions for
determining an orientation of a display of the user interface;
adapting a display view of said display depending on said determined orientation; and
assigning functions to input means of said user interface depending on said determined orientation.

32. The computer-readable medium according to claim 31, further comprising instructions for receiving information on said orientation from a user.

33. The computer-readable medium according to claim 31, further comprising instructions for receiving information on said orientation a sensor.

34. The computer-readable medium according to claim 31, further comprising instructions for launching an application depending on the determined orientation.
